(19) United States
(12) Patent Application Publication
(10) Pub. No.: US 2014/0220309 A1
(43) Pub. Date: Aug. 7, 2014

(54) GLASS FILM WITH SMOOTH AND MICROCRACK-FREE EDGE SURFACE AND MANUFACTURING METHOD THEREOF

(71) Applicant: Schott AG, Mainz (DE)

(72) Inventors: Jürgen Vogt, Oberheimbach (DE); Thomas Wiegel, Alfeld (DE); Holger Wegener, Alfeld (DE); Ulrich Neuhäusler, Diedorf (DE); Angelika Ullmann, Coppenbrugge (DE)

(73) Assignee: Schott AG, Mainz (DE)

(21) Appl. No.: 14/246,709

(22) Filed: Apr. 7, 2014

Related U.S. Application Data
(63) Continuation of application No. PCT/EP2012/004171, filed on Oct. 5, 2012.

(30) Foreign Application Priority Data
Oct. 7, 2011 (DE) 10 2011 084 129.6

(51) Int. Cl. C03B 29/00; C03C 17/02

(52) U.S. Cl. CPC C03B 29/00; C03C 17/02; C03C 2217/78
USPC 428/192; 65/111; 65/60.5

(57) ABSTRACT

A glass film has a first and a second surface which are both defined by like edges, wherein the surface of at least two edges which are located opposite one another have an average surface roughness of an maximum of 2 nanometers.

### CROSS REFERENCE TO RELATED APPLICATIONS

This is a continuation of PCT Application No. PCT/EP2012/004171, entitled “GLASS FILM WITH SMOOTH AND MICROCRACK-FREE EDGE SURFACE AND MANUFACTURING METHOD THEREOF”, filed Oct. 5, 2012, which is incorporated herein by reference.

### BACKGROUND OF THE INVENTION

1. Field of the Invention

The present invention relates to a glass film with a specially formed very smooth and microcrack-free edge surface.

2. Description of the Related Art

For greatly diverse applications, such as for example in the field of consumer electronics, for example as glass covers, for organic light-emitting diode (OLED) light sources or for thin or curved display devices, or in the field or regenerative energies or energy technology, such as solar cells, thin glass is increasingly used. Examples for this are touch panels, capacitors, thin film batteries, flexible circuit boards, flexible OLED's, flexible photo-voltaic modules or also e-papers. Thin glass is moving into focus more and more for many applications due to its excellent characteristics, such as resistance to chemicals, temperature changes and heat, gas tightness, high electric insulation properties, customized coefficient of expansion, flexibility, high optical quality and light transparency and also high surface quality with very low roughness due to a fire-polished surface of the two thin glass entities. Thin glass is herein to be understood to be glass films having thicknesses of less than approximately 1.2 millimeters (mm) to thicknesses of 15 μm and smaller. Due to its flexibility thin glass in the embodiment of a glass film is increasingly wound after production and stored as a glass roll, or transported for cutting to size and further processing. After an intermediate treatment, for example coating or cutting to size, the glass film can again be wound in a roll-to roll process and supplied to an additional application.

Compared to storing and transporting flat material, winding of the glass includes the advantage of a more cost effective, compact storage, transport and handling during further processing. In further processing smaller glass film segments are separated from the glass roll or from material which is stored and transported flat according to the requirements. In some applications these glass film segments are again utilized as bent or rolled glass.

With all of the excellent characteristics, glass as a brittle material generally possesses a lower breaking resistance since it is less resistant against stress. When bending, the glass stresses occur on the outer surface of the bent glass. For breakage-free storing and breakage-free transport of such a glass roll or for crack-free and breakage-free utilization of smaller glass film segments the quality and integrity of the edges are of importance in the first instance, in order to avoid a crack or breakage in the wound or curved glass roll. Even damage to the edges such as minute cracks, for example microcracks, can become the cause and the point of origin for larger cracks or breakages in the glass film. Moreover, because of the tension on the top side of the wound or curved glass film, integrity and freedom of the surface from scratches, grooves and other surface defects is important in order to avoid the development of a crack or break in the wound or curved glass film. Thirdly, manufacture related interior stresses in the glass should be as small as possible or nonexistent in order to avoid development of a crack or break in the wound or curved glass film. In particular, the quality of the glass film edge is of particular importance in regard to crack formation or crack propagation into a break of the glass film.

According to the current state of the art thin glasses or glass films are mechanically scored and broken with a specially ground diamond or a small wheel of special steel or tungsten carbide. Scoring the surface produces a targeted stress in the glass. Along the thus produced fissure the glass is broken, controlled by pressure, tension or bending. This causes edges having severe roughness, many microcracks and popping and conchoidal ruptures at the edges.

In order to increase edge strength these edges are subsequently usually edged, beveled or polished. Mechanical edge processing is no longer realizable for glass films, in particular at thicknesses less than 200 μm, without causing additional cracking or breakage risks for the glass.

In order to achieve better edge quality the laser scribing process according to the current state of the art is applied in order to break a glass substrate by means of a thermally generated mechanical tension. A combination of both methods is also known and used in the current state of the art. In the laser scribing method the glass is heated along a precisely defined line with a bundled laser beam, usually a CO₂ laser beam, and a thermal tension is produced in the glass by an immediately following cold jet of cooling fluid such as compressed air or an air-fluid mixture that is great enough that the glass is breakable or breaks along the predefined edge. A laser scribing method of this type is described for example in International Patent Publication Nos. DE 693 04 194 T2 and EP 0 872 303 B1 and U.S. Pat. No. 6,407,360.

However, this method also produces a broken edge with corresponding roughness and microcracks. Originating from the indentations and microcracks in the edge structure, tears can form and spread in the glass, in particular when bending or winding a thin glass film in a thickness range of less than 200 μm, which eventually lead to a break in the glass.

A suggestion is made in International Publication No. WO 99/46212 for increasing the edge strength. It is suggested to coat a glass sheet edge and fill microcracks originating from the glass edge with a highly viscous curable synthetic material. The coating can be applied by dipping of the glass edge into the synthetic material and curing with ultra-violet (UV) light. Protruding synthetic material on the outside surface of the glass sheet is subsequently removed. This method is suggested for glass sheets of 0.1 to 2 mm thickness. Herein it is disadvantageous that it includes several expensive additional process steps and that it is rather unsuitable for glass films in the range of 5 to 350 μm. In particular, on such thin glass films, protruding synthetic material cannot be removed without damaging the film. Moreover, coating of the glass edge and even filling of the microcracks as disclosed in International Publication No. WO 99/46212 prevents crack formation and spreading of cracks only to a limited extent. A highly viscous synthetic material as is suggested therein can only cover microcracks in the surface structure of the glass sheet edge superficially due to its viscosity. With accordingly acting tension, microcracks can therefore still act as a point of origin for spreading of cracks which then leads to breaking of the glass sheet.

To increase the edge strength of glass substrates in the thickness range of greater than 0.6 mm or respectively greater than 0.1 mm, International Publication No. WO 2010/135614 suggests surface coating of the edges with a polymer. The thickness of the coating should be in the range of 5 to 50 μm. However, here too such a coating prevents formation and spreading of cracks originating from the edge only to a limited extent as is explained in the document, since microcracks in the edge surface structure can lead unhindered from its depth to crack growth. Moreover, a coating process of this type of an edge with synthetic material on thin glass films in the range of 200 to 5 μm can only be implemented at great expense. Moreover it cannot be avoided, in particular with very thin films, that the coating at the edge forms thickenings which cannot be removed without the risk of damaging the film and which represent a great impairment during use or during winding of the glass film.

From International Patent Application Publication No. DE 10 2009 008292, a glass layer which is preferably produced in the down-draw or overflow-down-draw-fusion method has become known which has a root mean square average (RMS)—according to DIN ISO 1302 also defined as an arithmetic average roughness (Rₐ)—for the surface of between 0.4 and 0.5 nm. The roughness, however, does not refer to the edges which have another roughness than the center of the glass ribbon since, as described above microcracks can occur on the edge with the result that the edge strength of the glass ribbon is not sufficient for winding.

International Patent Application Publication No. DE 10 2008 046 044 describes a method for producing thermally hardened glass which uses a laser separation method for increasing edge strength in order to minimize microcracks originating from the edges, whereby fire-polishing may be used in addition or alternatively. However, it is not described in DE 10 2008 046 044 that a greater edge strength is thereby achieved for winding the glass ribbon into a roll.

International Patent Publication No. DE 100 16 628 describes containing of thin glass sheets by means of a soldering process with a solder, for example a solder glass. No mention is made of this in DE 100 16 628 that the edge strength can be increased with this, in particular that a greater edge strength for winding the glass ribbon into a roll can be achieved therewith.

What is needed in the art is a glass film which avoids the disadvantages of the current state of the art and which, in particular, has sufficient edge quality which will permit bending or rolling of the glass film wherein formation of a crack originating from the edge is largely or completely avoided. In particular, the edge strength is to be increased by such a measure, so that the probability of failure when winding a glass film ribbon into a roll having a roll diameter in the range of 50 mm to 1000 mm at a length of 1000 m is less than 1%.

### SUMMARY OF THE INVENTION

The glass film has a first and a second surface which are both defined by like edges, wherein the inventive surface of at least two edges which are located opposite one another have a root mean square average (RMS) Rq of not exceeding 1 nanometer, for example not exceeding 0.8 nanometer, especially preferably not exceeding 0.5 nanometer, measured over a length of 670 μm. The average surface roughness Ra of at least two edges which are located opposite one another measured over a length of 670 μm is a maximum of 2 nanometers, for example a maximum of 1.5 nanometer, or a maximum 1 nanometer.

Root mean square average (RMS) is understood to be the square mean value Rq of all distances measured in a specified direction within the referenced distance of the actual profile of a geometrically defined line, averaged by the actual profile. Averaged surface roughness Ra is understood to be the arithmetic mean from the individual surface roughness of five adjacent individual measuring distances.

According to the present invention the surface of at least two edges of the glass film which are located opposite one another consist of at least one metal oxide, for example of a metal oxide composite. In one embodiment of the present invention the composition of the metal oxide composite is largely identical with the composition of the glass film. In another embodiment of the present invention it may also be a special metal oxide or can be a composition of metal oxides that would be advantageous for producing the inventive very smooth microcrack-free surface of the edges and which would be consistent with the composition of a special fused solder glass.

In an additional embodiment of the present invention the at least two edges of the glass film which are located opposite one another have a fire-polished surface.

The at least two edges located opposite one another are understood to be edges which are bent during bending or rolling of the glass film. However, in addition also one or both edges progressing perpendicular to the bending radius may have the inventive configuration.

In an additional embodiment of the present invention the first and the second surface of the glass film, in other words, both surfaces of the glass film, may have a fire-polished surface. In this embodiment their surfaces have a root mean square average (RMS) Rq of not exceeding 1 nanometer, such as not exceeding 0.8 nanometer, or not exceeding 0.5 nanometer, measured over a length of 670 μm. Moreover, the average surface roughness (Ra) of their surfaces measured over a length of 670 μm is a maximum of 2 nanometers, for example a maximum of 1.5 nanometer or a maximum 1 nanometer.

In a further embodiment of the present invention it is achieved with the described measures such as thermal smoothing or melting of solder glass that the probability of failure, that is the probability of failure, that is the probability that the glass ribbon or respectively the glass film breaks, when evaluating a plurality of glass films having a length of 1000 meters (m) and a thickness in the range of 5 μm to 1.2 mm, such as 5 μm to 350 μm, or 15 μm to 200 μm when winding onto a roll having a diameter in the range of 50 mm to 1000 mm, for example 150 mm to 600 mm, is less than 1%.

In one embodiment of the present invention a glass film has a thickness of a maximum of 200 μm, such as a maximum of 100 μm, a maximum of 50 μm, or a maximum of 30 μm and at least 5 μm, such as at least 10 μm, or at least 15 μm and can be bent and wound in spite of the brittleness of glass without the risk of cracking or breaking.

In one embodiment one such inventive glass film has an alkaline oxide content not exceeding 2 weight -%, for example not exceeding 1 weight -%, not exceeding 0.5 weight -%, not exceeding 0.05 weight -%, or not exceeding 0.03 weight -%.

In one additional embodiment of the present invention one such inventive glass film consists of a glass which contains the following components (in weight -% on oxide basis):

| | |
|---|---|
| SiO₂ | 40-75; |
| Al₂O₃ | 1-25; |
| B₂O₃ | 0-16; |
| Alkaline earth oxide | 0-30; and |
| Alkaline oxide | 0-2. |

In a further embodiment one such inventive glass film consists of a glass which contains the following components (in weight -% on oxide basis):

| | |
|---|---|
| SiO₂ | 45-70; |
| Al₂O₃ | 5-25; |
| B₂O₃ | 1-16; |
| Alkaline earth oxide | 1-30; and |
| Alkaline oxide | 0-1. |

Especially suitable glass films can hereby be produced. The glass compositions are suitable to produce edges with the assistance of thermal smoothing or with wetting or fusing with a solder glass which have sufficient edge quality to permit bending or rolling of the glass ribbon, whereby formation of a crack originating at the edge is reduced or prevented.

The present invention moreover includes a method to produce a glass film which possesses sufficient edge quality that permits bending or winding of the glass film, wherein formation of a crack originating from the edge is reduced or eliminated.

In one embodiment a glass film is provided and at least two edges of the glass film which are located opposite one another are thermally smoothed, whereby the glass on the edge surface is heated to a temperature which is higher than the transformation temperature (T_{g}) of the glass of the glass film. The transformation point (T_{g}) is thereby the temperature at which the glass transitions during cooling from the viscous state to the solid state.

Such a glass film is produced from a molten glass, in particular glass having low alkaline content, in the down-draw method or in the overflow-downdraw-fusion method. It has been shown that both methods which are generally known in the current state of the art (compare for example International Publication No. WO 02/051757 A2 for the down-draw-method and International Publication No. WO 03/051783 A1 for the overflow-downdraw-fusion method) are suitable for drawing thin glass films having a thickness of less than 200 μm, for example less than 100 μm, or less than 50 μm and having a thickness of at least 5 μm, for example at least 10 μm, or at least 15 μm.

In the down-draw-method which is described in principle in International Publication No. WO 02/051757 A2, bubble-free and well homogenized glass flows into a glass reservoir, the so-called drawing tank. The drawing tank consists of precious metals, for example platinum or platinum alloys. Arranged below the drawing tank is a nozzle device, including a slotted nozzle. The size and shape of this slotted nozzle defines the flow of the drawn glass film, as well as the thickness distribution across the width of the glass film. The glass film is drawn downward by use of draw rollers and eventually arrives in an annealing furnace which is located following the draw rollers. The annealing furnace slowly cools the glass down to near room temperature in order to avoid stresses in the glass. The speed of the draw rollers defines the thickness of the glass film. After the drawing process the glass is bent from the vertical into a horizontal position for further processing.

After drawing the glass film has a fire-polished lower and upper surface in its two-dimensional expansion. “Fire-polished” means that the glass surface during solidification of the glass during thermal molding only forms through the boundary surface to the air and is not subsequently altered either mechanically or chemically. The area of the thus produced thin glass has thereby no contact during thermal molding with other solid or liquid materials. Both aforementioned glass drawing methods result in glass surfaces having a root mean square average (RMS) Rq of not exceeding 1 nanometer, for example not exceeding 0.8 nanometer, not exceeding 0.5 nanometer, or in a range of 0.2 to 0.4 nanometer and a surface roughness Ra not exceeding 2 nanometers, for example not exceeding 1.5 nanometer, not exceeding 1 nanometer, or in a range between 0.5 and 1.5 nanometers, measured over a length of 670 μm.

Located at the edges of the drawn glass film are process related thickenings, so-called laces on which the glass is pulled from the draw tank and guided. In order to be able to wind and bend the glass film in a volume-saving manner and also to a small diameter, it is advantageous or necessary to detach these laces. For this purpose a stress is created along a predefined breaking line using mechanical scoring and/or using a treatment with a laser beam with subsequent targeted cooling, wherein the glass is subsequently broken along this break line. The glass film is then stored flat or on a roll and transported.

The glass film can also be cut into smaller segments or sizes in a downstream process. In this case too, a stress is created prior to breaking the glass along a predefined breaking line, either using mechanical scoring or by utilizing treatment with a laser beam with subsequent targeted cooling, or through a combination of both methods. In each case a rough edge with microcracks and fissures occurs due to the breakage and these may act as point of origination for the formation and advancement or widening of a microcrack into a crack in the glass film.

In an additional step, according to the present invention, the glass is melted and thermally smoothed along this fracture line. The microcracks in particular close up through melting and thus heal and fractures and roughness smooth out. The surface is hereby heated to a temperature above the transformation point (Tg) of the glass so that the surface contracts due to the surface tension, smoothing out and thus creating a fire-polish. According to the present invention the heat input into the surface of the glass film is hereby kept low enough, so that no undesirable thickening of the glass film edge occurs. It is important hereby that the edge surface only becomes molten to a very limited depth, or that only small areas of the surface melt. There is no undesirable thickening if the thickening of the edge is no more than 25% of the glass thickness, for example no more than 15% of the glass thickness, or no more than 5% of the glass thickness.

In one embodiment of the present invention the glass film edge is guided through a chamber, for example consisting of a translucent fused quartz such as Quarzal by Schott AG., Mainz which is equipped with infrared sources. This leads to local heating of the glass edge above Tg, which results in a fire-polish (fusion) of the edge. A subsequent cooling process reduces the stresses in the glass edges which occurred due to the thermal stresses during melting.

In another embodiment of the present invention the edge is heated utilizing a laser. The energy input is selected at a level where the glass edge is heated above Tg and where its surface melts.

In an additional embodiment of the present invention the energy input occurs utilizing radiation through heating rods. The glass edge passes by these without making contact with them. In this case the heat input is also selected at a level high enough so that the glass edge is heated above Tg and its surface melts.

In one further embodiment of the present invention, the energy input occurs using a flame, for example a gas flame. The flame should burn as soot-free as possible. Basically all flammable gases such as for example methane, ethane, propane, butane, ethane or natural gas are suitable for this. One or several burners may be selected for this purpose. Burners having different flame configurations can be utilized. Suitable for this purpose are line burners or individual lance burners. In one embodiment, a jet pressure is created in the flame which counters the force of gravity of the melting glass on the surface of the glass film edge. Alternatively, the jet pressure can be built up independent of the flame and through its progression have a targeted influence over the softening glass on the glass film edge surface. In this manner a thickening of the glass film edge can be countered simultaneously with positive melting of the surface structure of the edge. A gas of this type can additionally support combustion of the flammable gas, for example an addition of oxygen or air.

In one alternative embodiment of the present invention, the at least two edges of the glass film which are located opposite one another and which are fractured are smoothed using an etching process. For this purpose the edges are subjected to the effects of hydrofluoric acid.

In one alternative embodiment of the present invention the at least two edges of the glass film which are located opposite one another and which are fractured are fused with a solder glass, so that in this case too an accordingly smooth and microcrack-free surface results. At a softening temperature of the solder glass below the transformation point (Tg) of the glass of the glass film, a fusion weld between both materials occurs, so that the heat input into the surface of the glass film can be kept low. The viscosity of the solder glass at flow temperature and wetting temperature is, for example, 10⁴ to 10⁶ deciPascals (dPas).

The composition of the solder glass is hereby coordinated with the glass of the glass film in such a way that the thermal coefficients of expansion of both materials are compatible. The deviation of the coefficient of expansion of the solder glass from that of the glass film is less than 2×10⁻⁶ Kelvin (K), for example less than 1×10⁻⁶/K, less than 0.6×10⁻⁶/K or less than 0.3×10⁻⁶/K. The thermal coefficient of expansion is selected in particular so that the solder glass as the mechanically weaker glass is under low compressive stress after cooling. In other words, the thermal coefficient of expansion of the solder glass is somewhat lower than that of the glass film. The solder glass is also adapted in its chemical composition to that of the glass film.

In one embodiment the glass solder according to the present invention is applied to the glass film edge in the form of a paste. To produce the paste, the glass powder is mixed homogeneously with a carrier fluid, for example water, methanol or nitrocellulose dissolved in amyl acetate. The paste is applied, for example, with a transfer roll or cylinder onto the glass film edge. The paste is subsequently dried which occurs through a still remaining internal heat of the glass film or an external heat- or possibly air input. Subsequently the glass powder is melted on the surface of the at least two edges of the glass film which are located opposite one another, whereby the solder glass moistens the surface.

The required thermal energy which is necessary for fusing can be provided by a gas flame. The thermal energy can be supplied even more targeted by a laser. It is possible hereby to align the radiation in such a way that the thermal energy is input, focused and spatially defined only where it is required for melting the glass film without heating a large surrounding area of the glass film. The energy necessary for melting the solder glass and wetting the edge surface is based on absorption of the provided laser radiation in the solder glass. The local energy input is chronologically and geometrically adjusted and input in such a manner that the viscosity that is required in the solder glass for flowing and wetting is achieved without evaporation of solder glass components occurring. This allows a thermal input into the surface of the glass film to be kept at a level low enough that no undesirable thickening occurs in the glass film edge.

Suitable solder glasses are, for example, solder glasses by Schott AG., Mainz—glass 8449, G018-223 or glass 8448. For a glass film consisting of glass AF32®eco by Schott AG., Mainz having an average thermal coefficient of linear expansion α (20° C. to 300° C.) of 3.2×10⁻⁶/K, a suitable solder, for example the glass solder by Schott A.G., Mainz—glass 8449 with α (20°C. to 300° C.) of 2.7×10⁻⁶/K, G018-223 with α (20° C. to 300° C.) of 3.0×10⁻⁶/K, G017-002 with a (20° C. to 300° C.) of 3.6×10⁻⁶/K or glass 8448 with α (20° C. to 300° C.) of 3.7×10⁻⁶/K is selected.

Based on the measures described above it is possible that the probability of failure, that is the probability that the glass ribbon, or respectively the glass film, breaks, when evaluating a plurality of glass films having a length of 1000 m and a thickness in the range of 5 μm to 1.2 mm, for example 5 μm to 350 μm or 15 μm to 200 μm when winding onto a roll having a diameter in the range of 50 mm to 1000 mm, such as 150 mm to 600 mm is less than 1%.

Table 1 specifies the edge strengths for various glass films, in other words the tensions in MegaPascals (MPa) which are created during winding of a glass film with a roll radius:

AF32 eco

| | | Diameter [mm] | | | | |
|---|---|---|---|---|---|---|
| E-Modulus | 74.8 | 75 | 175 | 250 | 375 | 500 |
| Glass thickness | 20 | 20 | 9 | 6 | 4 | 3 |
| [μm] | 50 | 50 | 21 | 15 | 10 | 7 |
| | 70 | 70 | 30 | 21 | 14 | 10 |
| | 100 | 100 | 43 | 30 | 20 | 15 |
| | 150 | 150 | 64 | 45 | 30 | 22 |
| | 200 | 199 | 85 | 60 | 40 | 30 |

D263 T eco

| | | Diameter [mm] | | | | |
|---|---|---|---|---|---|---|
| E-Modulus | 72.9 | 75 | 175 | 250 | 375 | 500 |
| Glass thickness | 20 | 19 | 8 | 6 | 4 | 3 |
| [μm] | 50 | 49 | 21 | 15 | 10 | 7 |
| | 70 | 68 | 29 | 20 | 14 | 10 |
| | 100 | 97 | 42 | 29 | 19 | 15 |
| | 150 | 146 | 62 | 44 | 29 | 22 |
| | 200 | 194 | 83 | 58 | 39 | 29 |

MEMpax

| | | Diameter [mm] | | | | |
|---|---|---|---|---|---|---|
| E-Modulus | 62.7 | 75 | 175 | 250 | 375 | 500 |
| Glass thickness | 20 | 17 | 7 | 5 | 3 | 3 |
| [μm] | 50 | 42 | 18 | 13 | 8 | 6 |
| | 70 | 59 | 25 | 18 | 12 | 9 |
| | 100 | 84 | 36 | 25 | 17 | 13 |
| | 150 | 125 | 54 | 38 | 25 | 19 |
| | 200 | 167 | 72 | 50 | 33 | 25 |

These are the AF32eco, D263Teco and MEMpax glasses by SCHOTT AG., Mainz. Tension σ in MPa is specified in dependency on the glass thickness d in μm, as well as dependency on diameter D in mm of the wound glass roll. The formula for determining the edge strength, in other words the tension on the outside of the glass ribbon, is calculated as follows.

σ=E·y/r

Whereby E is the elasticity modulus (E-modulus), y is half the glass thickness (d/2) of the glass ribbon which is to be wound and r is the wound radius of the wound glass ribbon.

With the values for σ from Table 1 and the knowledge of the probability of failure for a multitude of tests which are analyzed, the probability of failure (P) for a glass ribbon having a certain length and roll radius can be determined. The probability of failure represents a Weibull-distribution whose width is characterized by the Weibull-parameter.

The Weibull-distribution is a continuous probability distribution over the cumulative positive real numbers which are used to describe lifespans and rate of failure of brittle materials such as glasses. The Weibull-distribution can be used to describe failure rates of technical systems. The Weibull-distribution is characterized by the broadness of the distribution, the so-called Weibull-modulus. It generally applies that the larger the modulus, the narrower the distribution.

If one conducts 2-point bending measurements with test lengths of 50 mm, the probability of failure of glass ribbons having a length (L) can be determined as follows with the knowledge of the Weibull-modulus:

$$P ( L , r ) = 1 - exp ( - \frac{L}{l} {( \frac{σ ( r )}{μ} )}^{2} )$$

P is the probability of failure of the glass ribbon having a length (L) and at a roll radius (r); (L) is the length of the glass ribbon for which the probability or failure is determined; (1) is the relevant test length which is used in the 2-point test, for example 1=50 mm. ó (r) is the tension which occurs through winding with roll radius (r); μ is the tension β determined in the 2-point bending test in the Weibull-modulus which describes the width of the distribution and thereby the extensions to small strength properties.

The predetermination of the probability of failure makes it possible that, if one wishes to wind a glass ribbon having thickness (d) to a radius (r), and having a winding length of 1000 m and wishes to achieve a probability of failure of 1% (or less) and if the relevant test length of the 2-point measurement is 50 mm to establish the following condition:

$$- 14.5 < β \cdot ln ( \frac{σ ( r )}{μ} )$$

If one assumes σ (r) for the tension from Table 1, then the following results for parameter α that characterizes the system and which is also defined as “figure of merit”:

$$α = β \cdot ln ( \frac{σ ( r )}{μ} )$$

Value α is, for example, increased with the assistance of the inventive measures, for example from 12 to 14.5 due to the increase of the edge strength.

It is possible that in one embodiment of the present invention stresses occur due to thermal input into the thin glass. These stresses can lead to distortion of the thin glass, in particular the glass film, or can become the reason for the risk of breakage when bending or winding the glass. In this case the glass is relaxed in an additional embodiment of the present invention in an annealing furnace subsequent to smoothing of the edges. The glass film is thereby heated for example in an inline process with a predefined temperature profile and undergoes targeted cooling.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A glass film, comprising a first surface and a second surface, wherein each of said first surface and said second surface are defined by a plurality of like edges, a surface of at least two of said edges located opposite each other having an average surface roughness (Ra) of a maximum of approximately 2 nanometers (nm).

2. The glass film according to claim 1, said average surface roughness being a maximum of 1.5 nm.

3. The glass film according to claim 1, wherein the glass film has a length of approximately 1000 meters (m), a thickness in a range between approximately 5 micrometers (μm) and 300 μm, and a diameter of a roll of the glass film is in a range of between approximately 50 millimeters (mm) and 1000 mm, the glass film has a probability of failure of less than approximately 1%.

4. The glass film according to claim 1, said surface of said at least two opposing edges having a root mean square average not exceeding approximately 1 nm.

5. The glass film according to claim 4, said root mean square average not exceeding 0.8 nanometer.

6. The glass film according to claim 1, said surface of said at least two opposing edges consisting essentially of at least one metal oxide.

7. The glass film according to claim 1, said surface of said at least two opposing edges having a fire-polished surface.

8. The glass film according to claim 1, said first surface and said second surfaces of the glass film having a fire-polished surface.

9. The glass film according to claim 1, the glass film having a thickness of a maximum of approximately 200 μm.

10. The glass film according to claim 9, said thickness being a maximum of 100 μm.

11. The glass film according to claim 1, said thickness being at least 5 μm.

12. The glass film according to claim 11, said thickness being at least 10 μm.

13. The glass film according to claim 1, the glass film having an alkaline oxide content of a maximum of approximately 2 weight percent (%).

14. The glass film according to claim 13, said alkaline oxide content being a maximum of 1 weight %.

15. The glass film according to claim 14, said alkaline oxide content being a maximum of 0.5 weight %.

16. The glass film according to claim 1, wherein the glass film is formed of a glass including (in weight % on an oxide basis):

| | |
|---|---|
| SiO₂ | 40-75; |
| Al₂O₃ | 1-25; |
| B₂O₃ | 0-16; |
| Alkaline earth oxide | 0-30; and |
| Alkaline oxide | 0-2. |

17. The glass film according to claim 1, wherein the glass film is formed of a glass including (in weight % on an oxide basis):

| | |
|---|---|
| SiO₂ | 45-70; |
| Al₂O₃ | 5-25; |
| B₂O₃ | 1-16; |
| Alkaline earth oxide | 1-30; and |
| Alkaline oxide | 0-1. |

18. A method of producing a glass film, the method comprising the steps of:
providing a glass film; and
heating a glass of the glass film on an edge surface to a temperature above a transformation point (Tg) to thermally smooth at least two opposing edges of the glass film such that the glass film with a length of 1000 meters (m), a thickness in a range of between 5 micrometers (μm) and 350 μm, and a diameter of a roll of the glass film in a range of between approximately 50 millimeters (mm) and 600 mm has a probability of failure of less than 1%.

19. Method of producing a glass film, the method comprising the steps of:
providing a glass film;
applying a solder glass onto a surface of at least two opposing edges of the glass film; and
melting said solder glass on said surface of said at least two opposing edges of the glass film, said solder glass wetting said surface of said at least two edges such that the glass film with a length of 1000 meters (m), a thickness in a range of between 5 micrometers (μm) and 350 μm, and a roll of the glass film having a diameter in a range of between 50 millimeters and 1000 mm has a probability of failure of less than 1%.

20. The method according to claim 19, wherein prior to said application of solder glass, the method further comprises the steps of:
causing stress in the glass film along a predefined break line using at least one of:
mechanical scoring; and
treatment with a laser beam and subsequent targeted cooling; and
breaking the glass film along said predefined break line subsequent to said step of causing stress in the glass film.
